(19) United States
(12) Patent Application Publication
(10) Pub. No.: US 2026/0219956 A1
(43) Pub. Date: Jul. 30, 2026

(54) THREAD MAPPING OF MODEL INFERENCE DEPLOYMENTS

(71) Applicant: THE TORONTO-DOMINION BANK, TORONTO (CA)

(72) Inventors: Peter Starszyk, Waterloo (CA); Wen-Yang Ku, TORONTO (CA); Guangwei Yu, TORONTO (CA); Devinder Kumar, TORONTO (CA); Maksims Volkovs, TORONTO (CA)

(21) Appl. No.: 19/460,860

(22) Filed: Jan. 27, 2026

Related U.S. Application Data
(60) Provisional application No. 63/750,033, filed on Jan. 27, 2025.

(51) Int. Cl. G06F 9/50; G06F 9/38

(52) U.S. Cl. CPC G06F 9/5066; G06F 9/3885

(57) ABSTRACT

AI models such as boosted decision trees, neural networks, large language models (LLMs), and agentic systems are deployed with multiple multi-threaded workers to service requests in parallel. The processing configuration is analyzed to determine distance between thread execution units (e.g., vCPUs) and a mapping determined to optimize thread assignment to the thread execution units. The threads may be statically pinned to particular vCPUs to prevent thread migration and optimize throughput. The thread mapping accounts for thread workloads and core-to-core distance. The mapping may seek to maximize distance between worker main threads and may either minimize (compact) or maximize (spread) distance between threads within the same worker. The mapping may be determined as an optimization problem, such as an Integer Linear Problem (ILP) that defines an objective and various constraints for optimization.

### CROSS-REFERENCE TO RELATED APPLICATION

This application claims the benefit of U.S. Provisional Application No. 63/750,033, filed Jan. 27, 2025, the contents of which is hereby incorporated by reference in its entirety.

### BACKGROUND

This disclosure relates generally to model inference optimization and more particularly to thread mapping of model inference for multi-threaded workers on multi-core servers.

For many machine-learning (ML) or artificial intelligence (AI) models, low inference latency is a stringent requirement for deploying the model effectively in practice. While techniques such as model compression, feature caching, and hardware acceleration aim to reduce latency, limited attention has been given to optimizing thread placement of these applications, particularly with respect to the non-uniform memory access (NUMA) and inefficient scheduling characteristics of modern host systems. These characteristics can degrade the performance of multi-threaded applications, especially in high-contention environments.

The rise of high-concurrency real-time ML applications has made minimizing latency a critical priority. Unfortunately, modern servers run on NUMA architectures and use default task scheduling policies, both of which degrade performance of multi-threaded workloads and pose challenges for latency requirements. Additionally, there are many scenarios in which servers oversubscribe threads to cores, further exacerbating performance degradation. While performance optimization on NUMA systems is well studied, the combined impacts of NUMA, default scheduling, and thread oversubscription, particularly on inference for certain model types, such as tabular data with XGBoost architectures, remains a significantly underexplored research area.

To serve client connections in parallel, many current frameworks fork a designated number of worker processes when the server is initialized, each inheriting identical copies of application logic and environment variables, which serve clients in parallel throughout the life of the application. In addition, each worker may have a plurality of different threads that may execute in parallel, enabling multi-threaded execution of the worker process tasks. While implementing this multi-threaded, multi-worker concurrent processing on multi-core processing environments provides greater processing power for parallel workloads, their complex memory hierarchies can result in inefficient thread communication and increased memory latencies for multi-threaded applications. In addition, these servers typically use default task scheduling policies that optimize for general system-level objectives, such as fairness and load balancing, but ignore application-specific characteristics, leading to runtime inefficiencies. In addition, in many cases the number of total threads may differ from available concurrent hardware processing and may include provisioning more threads than hardware execution units (e.g., that can each process a given thread at a particular time). Additional threads may increase core utilization and reduce idling, often assigning dozens to sometimes hundreds of threads to a single core. However, this can also degrade performance when it leads to excessive context switches, loss of locality, and high resource contention.

### SUMMARY

To improve model inference performance, threads for a model inference application are pinned to particular thread execution units (i.e., each component of a processing core that processes a particular thread). After pinning, the threads are executed on the associated thread execution units and are prevented from migration to other thread execution units. The model inference application may be executed with a plurality of model processes (also referred to as workers) that each has a plurality of threads for performing associated tasks.

The threads are mapped to thread execution units based on various considerations, which may include distances between threads for the assigned thread execution units. The distance between thread execution units may be measured as a latency between the thread execution units, e.g., in retrieving data from one thread execution unit to another (e.g., retrieved from respective caches). In some embodiments, the distance is measured as a number of clock ticks for retrieval between caches. The thread mapping may use the execution unit distance to evaluate potential thread mappings, for example, to maximize distance between main threads of worker processes or to minimize (or maximize) the distance between threads associated with the same worker process. Additional considerations may include thread workload mapped to an execution unit, execution unit utilization, and other considerations.

The thread mappings to execution units may be determined based on these various considerations. In some embodiments, the mappings are evaluated based on thread assignments and the potential mappings are solved as an optimization problem based on the considerations. Particularly, in one embodiment, the optimization problem may be modeled as an Integer Linear Program (ILP) in which each consideration is characterized as a constraint.

The mapping may be determined based on the configuration of the computer model process (i.e., the number of concurrent worker processes and the set of threads for each worker) and the configuration of the execution units. In some embodiments, the mapping is determined based on the configuration information without requiring the executing computer model process. The mapping may then be applied when the computer model process is initialized to bind the various threads for the computer model process (i.e., across the various worker processes and the plurality of threads associated with each worker process) to the mapped execution units, such that the operating system executes each thread with its mapped execution unit.

This approach provides a thread execution unit mapping for AI inference pipelines for concurrent processing in a multi-threaded, multi-worker server using multi-core processing systems. Experiments also demonstrate improved performance of this mapping approach, averaging 1.13× over a commonly used Round Robin heuristic and 1.15× over the Linux default scheduler.

### BRIEF DESCRIPTION OF THE DRAWINGS

FIG. 1 illustrates an overview of an environment for model inference by a model inference server, according to one or more embodiments.

FIG. 2 shows example components of a model inference server, according to one or more embodiments.

FIG. 3 shows an example architecture for a processor package on which threads may be executed, according to one or more embodiments.

FIG. 4 provides an example process for optimizing thread mapping for a model inference server, according to one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

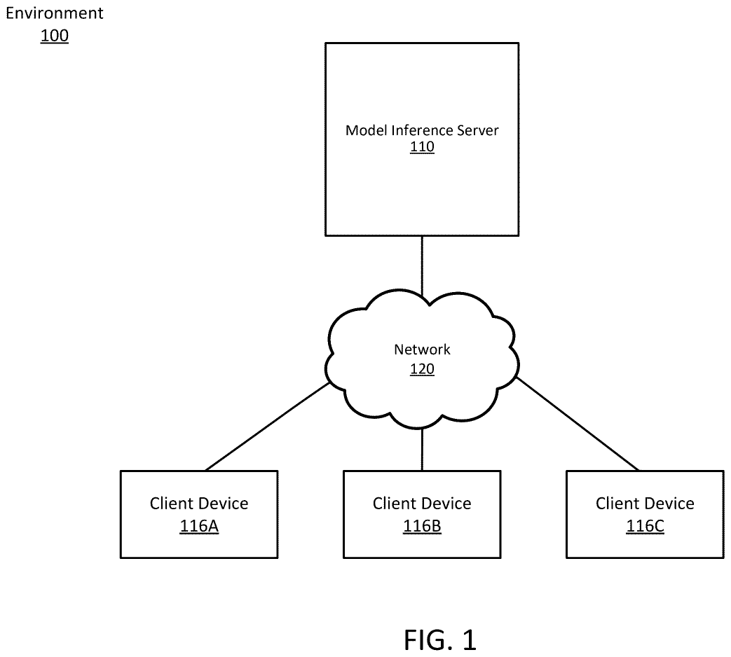

FIG. 1 illustrates an overview of an environment 100 for model inference by a model inference server 110, according to one or more embodiments. When a computer model (such as a large language model (LLM), neural network, convolutional neural network, autoencoder, embedding system, decision tree and the like) is deployed for inference, it may often be deployed to a model inference server 110 that communicates with a set of client devices 116A-C across a network 120 for handling requests to apply the computer model to data payloads. The computer model during inference and application by the model inference server 110 is typically applied with fixed parameters that were determined during training of the computer model. Accordingly, the model inference server 110 may be configured to receive and process many concurrent requests from various client devices 116A-C.

The client devices 116A-C may provide requests for the model to a common address or socket of the model inference server 110. The model inference server 110 may have a plurality of independently executing model processes (which may also be termed a “worker”) that are each capable of receiving and processing requests with a respective plurality of threads (“worker threads”). As requests are provided by the client devices 116 and received by the model inference server 110, worker processes are selected to receive and process the request and return the model output to the client device 116. As requests are received, the requests may be placed in a queue and executing worker processes receive requests from the queue and are typically slept (e.g., inactive, awaiting an input from the queue) on task completion. In some embodiments, the model inference server 110 provides access to the model as hypertext transfer protocol (HTTP) services accessible through a stable universal resource locator (URL). The client devices 116 send concurrent HTTP requests containing payloads to the URL, the server processes these payloads using the model pipeline, and responses are returned to clients. In many instances, these requests for model inference are stateless, short-lived, and follow a repeatable workload pattern.

As further discussed below, the worker processes are typically multi-threaded and may present asymmetric workload demands (i.e., for a particular worker process, different threads may require different amounts of processing). To more effectively use multi-threaded processing of the model inference server 110, the model inference server 110 may map the worker threads to particular thread execution units (e.g., vCPUs) and bind execution of the worker threads to the mapped thread execution units to optimize execution of the worker processes and improve throughput of the overall model inference server 110. The mapping of the worker threads may include consideration of the distance across different worker threads (i.e., across different workers), distance within worker threads (for the same worker), over/under subscription of the thread execution units, and so forth. As discussed further below, the distance between threads may be measured by the “distance” between assigned thread execution units, which may be measured by memory access latency between the associated thread execution units.

### AI Model Workers on Parallel-Processing (Multi-Core) Systems

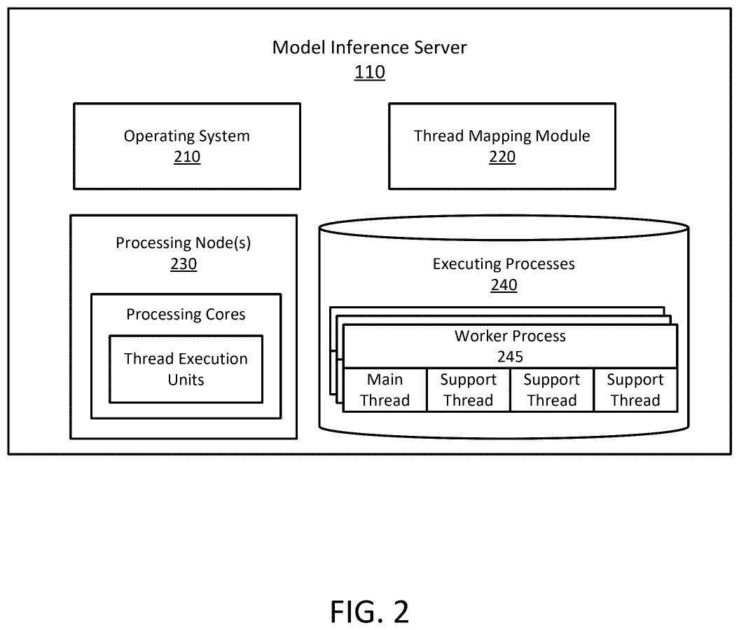

FIG. 2 shows example components of a model inference server 110, according to one or more embodiments. Certain components are illustrated (and others omitted) for convenience in this disclosure; additional configurations may include different or fewer components in various embodiments. The model inference server 110 includes various components for performing concurrent and parallel handling of model inference requests. Particularly, the model implemented by the model inference server 110 may be any suitable type of model having learned parameters and typically include multi-staged or multi-layered processing steps by the model. Models may thus include decision trees, neural networks, encoders, decoders, autoencoders, attention mechanisms, transformers, agentic systems, and so forth that include various types of processing for inputs to obtain relevant outputs. In addition to the model processing itself (i.e., the model's processing of an input to an output), the inference process may include various pre-processing and post-processing steps such as data cleansing, verification, encoding/embedding, and calculating feature contribution (e.g., a post-processing step to determine Shapley feature contribution of input features).

The model inference server 110 includes a plurality of worker processes 245 that may each include a plurality of threads for handling a request and providing the associated processing for a request. A plurality of worker processes 245 may be instantiated that represent the number of requests that may be accepted in parallel, and each of the worker processes 245 may include a plurality of threads for processing a request. Each worker process 245 thus may include a plurality of threads that may execute the worker process and may include threads that perform different amounts of work for a particular request. For example, a worker process 245 may have a main thread responsible for single-threaded steps of the inference process (e.g., payload deserialization or data type conversion for incoming requests) and additional threads (termed “support threads”) that are used for multi-threaded steps of the inference process (e.g., computing model predictions or Shapley feature contribution scores).

To serve client connections in parallel, the worker processes 245 may use a “pre-fork” model, such that the plurality of worker processes for handling requests are created before requests are received, rather than forked as requests are received. This approach eliminates the overhead by forking multiple processes (i.e., workers) at server instantiation, each inheriting identical copies of application logic and environment variables, which serve clients in parallel throughout the life of the application. The particular technologies used in this approach may vary depending on the server, operating system 210, language usage, and so forth. As examples, the model inference server 110 may include an Apache HTTP server, Gunicorn, and Open Multi-Processing (OpenMP) as frameworks for servicing requests, worker processes 245, and multi-threaded model processing. As one example, the worker processes may be associated with a variable that specifies a number of worker processes to initiate, each of which may have a plurality of associated threads (e.g., a thread pool) for performing related tasks for a request.

When the model inference server 110 is initialized for model inference, the various worker processes 245 may be initiated as a set of executing processes 240 managed by the operating system 210. The operating system 210 controls and schedules execution of the executing processes 240 on thread execution units of one or more processing nodes 230.

To provide enhanced parallelism, modern systems have adopted architectures supporting multiple processing nodes 230, multiple sockets per node, and multiple processing cores per socket. Further, “hyperthreading” (simultaneous multi-threading) technology provides for each physical core to execute multiple flows of control. That is, each flow of control can be understood as being processed by a “thread execution unit” that executes processing related to a particular thread even though it is co-located on a processing core with one or more additional thread execution units. This may also be considered a logical core abstraction or as a “vCPU” because each thread execution unit may logically perform as a distinct processing unit (i.e., CPU) that executes instructions of one thread.

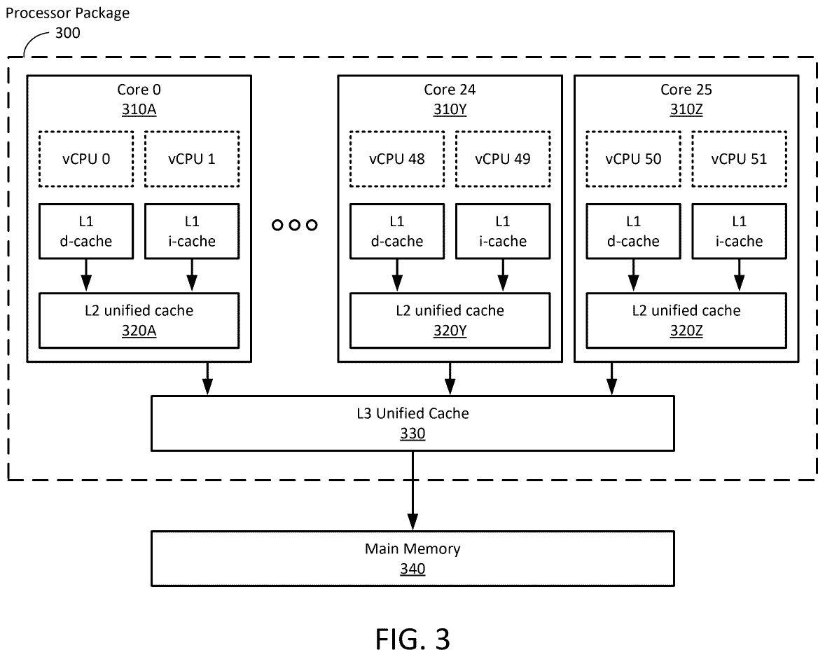

FIG. 3 shows an example architecture for a processor package 300 on which threads may be executed, according to one or more embodiments. In this example, the processor package 300 includes 26 cores 310, each of which may include two thread execution units (labeled as vCPU) for a total of 52 thread execution units. The example processor package 300 is a homogeneous system in which all cores share identical design and functionality characteristics. Each physical core 310A-Z has its own L1 caches which store most-recently fetched instructions (i-cache) and data (d-cache), and a L2 unified cache 320A-Z, all shared on a particular core 310. All cores 310 on the processor package 300 share one L3 unified cache 330, and the processor is connected to main memory 340 through the memory bus.

In this design, threads contend for shared resources like caches and interconnects. How cores are interconnected through the cache hierarchy, where threads and data are co-located, the degree of data sharing between threads, and other considerations may vary in different embodiments. While this example shows a multi-core, single-node environment, the thread mapping approach discussed herein may also be applied across multi-node environments and provide mapping in multi-node cluster environments.

### Thread Mapping

Returning to FIG. 2, the operating system 210 may view the thread execution units as homogenous processing units capable of executing concurrent threads (e.g., with one thread executing at each thread execution unit), but may not natively consider characteristics of the thread execution units or worker processes 245 in managing the executing processes 240. The operating system 210 may schedule execution of the executing processes 240 in various ways. As a default, the operating system 210 may schedule execution of the executing processes 240 on thread execution units with a default scheduler that may permit thread migration and is typically not optimized for multi-threaded, AI-focused workloads.

For example, the default scheduler in Linux is the “Completely Fair Scheduler” (CFS). On multi-core systems, each core maintains its own runqueue (red-black tree) data structure that orders tasks assigned to it based on a dynamic value, virtual runtime (vruntime). To ensure fairness, CFS prioritizes running tasks with lower vruntime (underserved tasks) so that tasks have a fair share of the processor. Periodically, CFS performs load balancing to ensure that tasks are evenly distributed across cores.

Although CFS aims to optimize for fairness and load balancing, it is application-agnostic. It schedules threads independently of one another which can lead to undesired contention for shared resources depending on their data sharing characteristics. Worse, its load-balancing feature leads to thread migrations. When a thread is migrated to a different core between runs, its data is not stored in the local caches on the new core. This may lead to cache misses on the new core and cache invalidations on the old core and consequently higher memory latencies. Thus, CFS can lead to performance degradation for multithreaded applications. Due to its dynamic and application agnostic nature, CFS may schedule multiple high-load threads on the same core at any given time.

Alternatively, the executing processes 240 may be pinned or “bound” for execution on a particular thread execution unit by the operating system 210, such that the thread is executed exclusively by the assigned thread execution unit. In some cases, the operating system 210 may bind a thread to a thread execution unit with a “CPU affinity” command that establishes an “affinity” for a thread to be executed on the associated thread execution unit.

To optimize the thread mapping, a thread mapping module 220 may determine a thread mapping for the set of worker processes 245. Particularly, the thread mapping module 220 may receive (or otherwise determine) information describing the configuration of the available thread execution units and worker processes 245 and determine a mapping of threads for the worker processes to the thread execution units. The operating system 210 may then use the thread mapping to bind threads of each worker process 245 to the mapped thread execution units. In some embodiments, the thread mapping module 220 may be performed “offline” based on information about the worker process configuration and thread execution unit configuration without requiring concurrent execution of the worker processes 245. In additional examples, the thread mapping module 220 may determine a mapping for worker processes 245 while the worker processes are executing, enabling dynamic mapping of threads as worker processes 245 may be instantiated or removed. In some configurations, the number of worker processes 245 may change during operation of the model inference server 110, such that the dynamic assignment of thread execution units may be used to optimize thread mappings responsive to a new worker process 245 being created or an existing worker process 245 ending.

The thread mapping module 220 may perform the thread mapping with various considerations and determine the mapping as an optimization problem. The thread mapping module 220 may parameterize the considerations and optimization problem in a variety of different ways. As one example, the thread mapping module 220 may describe the optimization problem as an Integer Linear Program (ILP) in which the various considerations are described as linear constraints to be optimized in the determination of thread assignments to thread execution units. As such, considerations such as “no more than one main thread of a worker process may be assigned to each thread execution unit” may be parameterized as a constraint for the solution of the ILP. Using the various considerations parameterized for the particular optimization problem formulation, the thread mapping module 220 may apply a solver or other solution space exploration algorithm to determine an optimized thread mapping. As such, although the particular optimization problem discussed below relates to an ILP formulation (e.g., describing considerations as formal constraints for the ILP), in additional embodiments, the thread mapping module 220 may parameterize the various considerations discussed herein in different ways to determine a suitable thread mapping. The thread mapping may thus include consideration of multiple factors that may be jointly optimized; in the ILP formulation (as discussed below), the factors may be defined as constraints in evaluating an optimization function for the ILP solver.

Generally, the thread mapping module 220 may determine a thread mapping that treats each of the thread execution units to be functionally equivalent and that each worker process 245 handles an equivalent load over time (e.g., that the operating system 210 will rotate through the worker processes 245 with each request). Similarly, the thread mapping module 220 may also consider the workload of each thread of the worker processes 245, expecting that the main thread of a worker handles a higher workload than other threads (e.g., support threads) of the same worker process 245, as the main thread manages both parallel tasks (e.g., model execution) and non-parallel tasks (e.g., request parsing and synchronization). The support threads share the workload equally over time, focusing on batch data processing.

As one consideration, in some embodiments, the thread mapping module 220 may use distances between thread execution units to characterize relationships between threads assigned to particular thread execution units. The distance between thread execution units may be estimated based on communication latency between the thread execution units. That is, the “distance” between thread execution units may be determined based on the amount of time for a thread execution unit to obtain information from another thread execution unit. When the thread execution units for two threads share a processing core, the information may be accessible on an L1 cache (as shown in FIG. 3), and otherwise may be accessible at a higher cache level, such as an L3 cache in the configuration shown in FIG. 3. In various configurations, the latency between data access at different cache levels may differ and in some configurations the thread execution units may not share similar unified cache storage as shown in FIG. 3. In some embodiments, the thread mapping module 220 may measure the distance between two thread execution units based on the number of clock cycles required to access a nearest cache in common between two subject thread execution units.

In one embodiment, the distance is measured by instantiating two threads t, t′ that run in parallel on thread execution units c and c′ and measuring latency between them. The distance may be measured by thread t read/writing a word that is currently stored in local cache of thread t′. The thread execution unit c generates the virtual address for the word and issuing a read/write request that will check each cache level in the memory hierarchy until there is a hit with thread execution unit c′. The resulting number of clock cycles for returning the word to c may be used as the distance between c and c′.

The distance between a number of thread execution units C, may be described in a matrix D ∈ [symbol] ^{|C|×|C|} in which entries d_{c,c′} specifies the distance d between two thread execution units c and c′ as an integer (Z). One example of a matrix D is:

$$c = 0 c = 1 c = 2 c = 3 …$$

$$𝒟 = ( \begin{matrix}0 & 4 & 50 & 50 & … \\ 4 & 0 & 50 & 50 & … \\ 50 & 50 & 0 & 4 & … \\ 50 & 50 & 4 & 0 & … \\ ⋮ & ⋮ & ⋮ & ⋮ & ⋱\end{matrix} ) \begin{matrix}c = 0 \\ c = 1 \\ c = 2 \\ c = 3 \\ ⋮\end{matrix}$$

The distance between two thread execution units is typically symmetric (e.g., the matrix D is symmetric), although in some architectures the time to access a common cache may be unequal between two thread execution units. The thread mapping module 220 may determine the distance between thread execution units based on provided information about the thread execution units or may determine the distance by execution threads at respective thread execution units and measuring the cache access timing (e.g., as clock cycles). In some embodiments, the distance for a thread execution unit and itself may be specified as zero. While access times differ across different architectures, an approximate access time on modern systems is around 4 cycles for L1 cache, 10 cycles for L2 cache, 50 cycles for L3 cache and 200 cycles for L4 cache. In some embodiments, the thread mapping module 220 may estimate distances between thread execution units based on architecture information of the processing node 230.

The thread mapping module 220 may then use the distance between thread execution units to determine the mapping of threads to thread execution units. Particularly, the distance between cores may be used to measure the distance between thread execution units for assigned threads. The distance between threads (on assigned processing units) may be used as an objective and/or constraint for the thread mapping process. To account for the different (typically, increased) workload of the main threads for each worker and that the workers may each process requests independently, the thread mapping may have an objective to maximize the distance between the main threads of each worker. As another example, the mapping may be based on the distance between assignments for threads associated with each worker. For example, the mapping may also aim to minimize the distance between threads for a given worker as a “compact” configuration or may aim to maximize the distance between threads for a given worker as a “spread” configuration for the threads.

The following notation and nomenclature is used in the further discussion below:

TABLE 1

| Notation | Definition |
|---|---|
| W | Number of server workers |
| T | Number of threads per worker |
| C | Number of logical cores (vCPUs) |
| V | Number of vCPUs per physical core |
| w ∈ {0, ... , W − 1} | Index and set of workers |
| t ∈ {0, ... , T − 1} | Index and set of threads for some worker; t = 0 |
| | indicates a main thread |
| c ∈ {0, ... , C − 1} | Index and set of vCPUs |

$x ∈ \{ 0 , … , \frac{C}{v} - 1 \} \qquad Index and set of physical cores$

| | |
|---|---|
| d_{c,c′} | Distance between vCPUs c, c′ |
| T_{wt,c} | Binary decision variable for thread t of worker w |
| | assigned to vCPU c |
| L(L⁺) | Lower limit of threads assigned to each logical |
| | (physical) core |
| U(U⁺) | Upper limit of threads assigned to each logical |
| | (physical) core |

In Table 1, for convenience, thread execution units are referred to in Table 1 as vCPUs and as “logical cores,” while “physical core” refers to processing cores that may collocate a plurality of logical cores, such as a core 310 shown in FIG. 3. The binary decision variable Y_{w,t,c}=1 indicates that thread t of worker w is assigned to thread execution unit c, while the binary decision variable Y_{w,t,c}=0 indicates no assignment.

In one embodiment, the distance between two main threads (t=0) for worker w and w′ mapped to different thread execution units c and c′ is determined by:

$$dist ( t = 0 \vert w , {t}^{′} = 0 \vert {w}^{′} ) = ( {\sum }_{w} {Y}_{w , t = 0 , c} ) ( {\sum }_{w} {Y}_{w , t = 0 , {c}^{′}} ) {d}_{c , {c}^{′}} \qquad Equation 1$$

As such, the total distance between main worker threads may be determined in some embodiments as:

$${f}_{m a i n} = {\sum }_{c} {\sum }_{{c}^{′} > c} dist ( t = 0 \vert w , {t}^{′} = 0 \vert {w}^{′} ) \qquad Equation 2$$

In various embodiments, the distance between worker threads may be one objective to be maximized by the thread mapping of thread mapping module 220, for example via Eq. 2. By maximizing distance between main worker threads, the likelihood that main worker threads affect one another (e.g., by mapping of additional related threads) can be minimized.

In addition or as an alternative, distance between threads within a given worker may also be used as at least a part of an objective function for the assignment. That is, the distances for a main thread and the support thread(s) assignment may be measured and used as an objective for the thread mapping. In some embodiments, the within-worker thread distances may be an objective to be minimized (for a “compact” arrangement) and in others the within-worker thread distances may be an objective to be maximized (for a “spread” arrangement). Formally, the distance between a thread t of a particular worker w and another thread t′ of the same worker may be measured as:

$$dist ( t = \vert w , {t}^{′} \vert w ) = ( {\sum }_{t} {Y}_{w , t , c} ) ( {\sum }_{t} {Y}_{w , t , {c}^{′}} ) {d}_{c , {c}^{′}} \qquad Equation 3$$

As a corresponding overall function to be optimized for thread distance within a worker, in one embodiment, the optimization function may include:

$${f}_{m o d e} = {( - 1 )}^{𝕀 ( compact )} {\sum }_{w} {\sum }_{c} {\sum }_{{c}^{′} > c} d i s t ( t \vert w , {t}^{′} \vert w ) \qquad Equation 4$$

in which the “mode” may designate whether to maximize or minimize this optimization function for threads within a worker. The total logical distance between all within-worker threads may be determined according to Eq. 4 and minimized in a “compact” mode and maximized in a “scatter” mode. The equations of Eq. 2 and 4 may be used in some embodiments to define an objective for generating the thread mapping and account for distances between worker main worker threads and threads within the same worker. In various embodiments, different formulations for distance measurements may also be used.

In addition to evaluating distance between cores assigned to threads, various additional considerations may also be included in determining a thread mapping. In some embodiments, these considerations may be defined as constraints of the solution explored by an optimization of the thread mapping module 220. Particularly, in the examples below, the considerations may be defined in equations that may be evaluated as constraints in an ILP formulation. The considerations, when used, may be similarly or equivalently treated in alternate optimization approaches.

Initially, certain additional constraints may be applied that may globally constrain the mapping solutions, particularly for across-worker and within-worker thread assignments.

First, as the main thread may perform more work than other threads for the same worker, when the number of workers is lower than the number of thread execution units W≤C, no two main threads across workers should compete for the same thread execution unit. A thread execution unit that is assigned more main threads than necessary can bottleneck the application, especially under high system load when all workers are processing requests in parallel. This may be addressed by assigning workers to maximize the distance across worker threads as discussed above. As an additional constraint, this principle may be further generalized, such that no two equally-ranked threads across workers compete for the same thread execution unit. This approach may address situations in which the workload across support threads is not uniformly distributed, preventing the “higher” workload support threads from being co-located unless necessary.

As another constraint, unless the number of threads for each worker exceeds the number of available thread execution units, no two threads within a worker should content for the same thread execution units. Stated another way, when T≤C, no two threads for the same worker should have an assignment (Y_{w,t,c}=1) to the same thread execution unit. Otherwise, one thread for a given worker may unnecessarily starve while another thread for that worker executes.

These may be formalized in additional constraints (e.g., in the ILP formulation):

$${\sum }_{c} {Y}_{w , t , c} = 1 ∀ w , t \qquad Equation 5$$

$${\sum }_{w} {Y}_{w , t , c} \leq 1 ∀ t , c \qquad Equation 6$$

$${\sum }_{t} {Y}_{w , t , c} = 1 ∀ w , c \qquad Equation 7$$

where Eq. 5 formalizes that the thread mapping is a static thread assignment of many threads to one thread execution unit, such that the sum across thread execution units for each thread of each worker is an assignment of one thread execution unit for the thread. That is, that only one thread assignment variable is set to 1 for each unique thread for each worker. Eq. 6 ensures that under the condition that there are not more workers than thread execution units W≤C, all equally ranked threads across workers are assigned to a unique thread execution unit relative to each other. Eq. 7 formalizes that when the number of threads for each worker is not greater than the number of thread execution units T≤C, all threads within a worker are assigned to a unique thread execution unit relative to each other.

The considerations may also include balancing workloads and overall volume across thread execution units and/or across cores (e.g., that may each have multiple thread execution units). The workload/volume may be balanced across thread execution units and/or cores in various ways in different embodiments. In addition to determining “fair” distribution of threads, the thread mapping for thread execution units may also consider the type of threads, such that when the threads cannot be evenly mapped, higher-workload threads (e.g., main threads) are prioritized to a thread execution unit with a lower thread count. Similarly, the mapping for physical cores differ based on whether the threads are to be “compact” or “spread”, such that a compact configuration may prioritize “oversubscribing” cores when the threads are “compact” and a spread configuration prioritizes more evenly distributes threads across different physical cores.

For balancing workloads across thread execution units, there may be three scenarios depending on total application thread count (W·T) and available thread execution units (C): first, the total application thread count is exceeded by thread execution units (fewer total threads than thread execution units); second, the total application thread count is evenly divisible by thread execution units; and third, the total application thread count exceeds and is not equally divisible by thread execution units (e.g., dividing threads evenly across execution units will yield a remainder that will be unevenly distributed to the thread execution units).

In some embodiments, balancing workload across thread execution units is performed based on a fair lower bound

$$L = ⌊ \frac{W \cdot T}{C} ⌋$$

and fair upper bound

$$U = ⌈ \frac{W \cdot T}{C} ⌉$$

that represent the total threads divided by the number of thread execution units as rounded up or rounded down. As a formalized constraint for thread mapping (e.g., in an IPL formulation), thread execution unit fairness may be defined as:

$$L \leq {\sum }_{w} {\sum }_{t} {Y}_{w , t , c} \leq U ∀ c \qquad Equation 8$$

such that the assigned thread mapping variables (Y_{w,t,c}) when summed across workers and across threads is between the lower bound L and upper bound U for each of the thread execution units, such that the constraint is true for all of the thread execution units.

Regarding the scenarios above, Eq. 8 is sufficient for scenario 1 when there are fewer total threads than thread execution units, each thread execution unit is assigned either L=0 or L=1 threads. It is also sufficient for scenario 2 because the threads can be evenly divided, such that the lower bound and upper bound are the same and thus each thread execution unit is assigned an equal number of threads. Scenario 3 requires additional consideration because there will be a remainder of threads that must be unevenly allocated to the thread execution units. This allocation decision is not effectively addressed by “Round Robin” mapping but is non-trivial because of the different workloads handled by different threads within a particular worker. For example, the main thread for each worker is expected to perform more work than the support threads.

To address the differing workload of different threads (here, assuming that the main thread for a worker is a higher workload than the others), there may be two subcases for scenario 3: a) the number of workers is equal to or exceeded by the number of thread processing units that can be assigned the lower bound L (e.g., (W≤C−r)); and b) the number of workers exceeds the number of thread processing units that can be assigned the lower bound L (e.g., (W>C−r)). In the first case, each of the main threads (or otherwise identified higher-workload threads) is assigned a thread processing unit with the lower bound of thread assignments, such that the higher workload of the threads is accounted for with a reduced total number of threads mapped to that thread processing unit, reducing potential contention for those thread processing units. In the second case, there are insufficient thread processing units to avoid at least one thread processing unit assigned a main thread and also a total number of threads at the upper bound of threads while attempting to “evenly” distribute threads. Stated another way, there are W thread processing units that are assigned a main thread but not enough remaining thread processing units to ensure that at all of the W thread processing units will only be assigned L threads.

Although the number of worker threads, total threads, and number of thread execution units may mean that an “even” distribution of threads mapped to thread execution units cannot avoid overlapping a main thread, the mapping may nonetheless aim to minimize the number of these overlaps.

In the ILP formulation, the distribution of main threads and maximizing the number of main threads having the lower bound L of mapped threads may be enforced with additional constraints using additional constraints that indicate whether a main thread is assigned to each thread processing unit and to limit excess assignment of threads to these thread processing units. Particularly, this can be parameterized for ILP with an auxiliary variable M_{c}, which indicates whether some main thread is assigned to a thread processing unit c:

$${M}_{c} \geq {Y}_{w , t = 0 , c} ∀ w , c \qquad Equation 9$$

$${M}_{c} \leq {\sum }_{w} {Y}_{w , t = 0 , c} ∀ c \qquad Equation 10$$

Eq. 9 ensures that M_{c} is 1 if any main thread is assigned to a respective thread processing unit c, while Eq. 10 ensures that M_{c} is 0 if none of the main threads have been assigned to c. Then, for each thread processing unit, an “event” may define whether the thread processing unit is assigned a main thread and has the upper bound U of assigned threads. Particularly, an event E_{c} is defined in one embodiment as the intersection of a thread processing unit having a main thread and a thread processing unit having the upper bound U of assigned threads:

$${E}_{c} = {E}_{c}^{1} ⋂ {E}_{c}^{2} where {E}_{c}^{1}$$

indicates thread processing unit c is assigned U total threads and

$${E}_{c}^{2}$$

indicates thread processing unit c is assigned a main thread. This may be formally calculated in one embodiment of an ILP formulation as a constraint based on the auxiliary variable M_{c}:

$$𝕀 ( {E}_{c} ) = ( {\sum }_{w} {\sum }_{t} {Y}_{w , t , c} - L ) {M}_{c} {∀}_{c} \qquad Equation 11$$

Because Eq. 11 is bounded between 0 and 1, a corresponding constraint may be determined in the ILP formulation as summing the total count of events E_{c} over all thread processing units and constrain the sum to be equal to or below a maximum based on the remainder and the number of thread processing units that do not have main threads:

$${\sum }_{c} 𝕀 ( {E}_{c} ) \leq max \{ 0 , W - C + r \} \qquad Equation 12$$

Using Eq. 12, as a constraint for a mapping problem may formalize the constraint, such that the number of thread processing units with an assigned main thread and also having the upper bound U of total assigned threads is limited based on the division of threads (particularly, its remainder r) and other thread processing units that do not have main threads (i.e., W−C).

In addition to determining an even workload across thread processing units, additional or alterative considerations may aim to balance workload and volume across cores via where each core has v thread execution units. As such, the number of cores may be defined as. Similar to the workload distribution across thread execution units described above, the thread mapping may apply workload constraints at the physical core level with some minor differences. For the core workload assignments, there are also three scenarios: first, the number of application threads is exceeded by cores

$$( W \cdot T < \frac{C}{v} ) ;$$

second, the total number of application threads are divisible by cores

$$( W \cdot T mod \frac{C}{v} = 0 ) ;$$

and third, the number of application threads exceeds and is not equally divisible by cores

$$( W \cdot T > \frac{C}{v} and W \cdot T mod \frac{C}{v} > 0 ) .$$

Fair lower and upper bounds of thread volume per core may differ in scatter and compact modes; scatter mode requires spreading remainder threads as evenly as possible across cores while it is acceptable to saturate cores with remainder threads maximally under compact mode.

To implement the thread mapping with respect to cores, fair lower bound L⁺ and fair upper bound U⁺ may thus differently defined for scatter (spread) and compact modes, such that

$$( {L}^{+} , {U}^{+} ) = ( ⌊ \frac{v \cdot W \cdot T}{C} ⌋ , ⌈ \frac{v \cdot W \cdot T}{C} ⌉ )$$

for scatter and

$$( v ⌊ \frac{v \cdot W \cdot T}{C} ⌋ , v ⌈ \frac{v \cdot W \cdot T}{C} ⌉ )$$

of thread volume that could be assigned to each core under scatter and compact modes, respectively.

$${L}^{+} \leq {\sum }_{w} {\sum }_{t} {\sum }_{i = 0}^{v - 1} {Y}_{w , t , c = vx + i} \leq {U}^{+} ∀ x \qquad Equation 13$$

Eq. 13 is sufficient for the first scenario of fewer threads than physical cores because each core is assigned either L⁺=0 or L⁺=1 threads for scattering or between 0 and v for compact mode. It is also sufficient for the second scenario of equally divisible threads across the cores because L⁺=U⁺ and thus each core is assigned an equal number of threads. Again, the third scenario requires additional consideration because there will be a remainder of r=W·T mod C threads that must be allocated to the C/v, and this may differ depending on whether the thread mapping is solving for scatter or compact-like placements.

For example under the scatter mode,

$$\vert {U}^{+} - {L}^{+} \vert \leq 1 , {r}^{+} = W \cdot T mod \frac{C}{v}$$

cores must be assigned U⁺ threads and

$$\frac{C}{v} - {r}^{+}$$

cores must be assigned L⁺ threads. If the number of workers is exceeded by the number of cores that can be assigned L⁺ threads

$$( W \leq \frac{C}{v} - {r}^{+} ) ,$$

we have W cores that are assigned a main thread and thus it is feasible and beneficial to assign these cores a total of L⁺ threads (1 main thread and L⁺−1 peer threads) each and the remaining cores U⁺ peer threads each so as not to over assign workloads. If the number of workers exceeds the number of cores that can be assigned L⁺ threads W>Cᵥ−r⁺, there are W cores that are assigned a main thread but not enough remaining cores to ensure at all of these W cores will only be assigned L⁺ threads. Under compact mode, |U⁺−L⁺|≤v, giving the ILP flexibility to saturate cores with v threads before saturating another, leading to different conditional criteria.

In the ILP formulation, the assignment of threads to cores and whether the cores are saturated may be implemented with a binary auxiliary variable Mₓ, which indicate whether some main thread is assigned to a core x:

$${M}_{x} \geq {Y}_{w , t = 0 , c = vx + i} ∀ w , i ∈ \{ 0 , … , ν - 1 \} , x \qquad Equation 14$$

$${M}_{x} \leq {\sum }_{w} {\sum }_{i = 0}^{v - 1} {Y}_{w , t = 0 , c = vx + i} ∀ x \qquad Equation 15$$

Eq. 14 ensures that Mₓ is 1 if any main thread is assigned on core x while Eq. 15 ensures that Mₓ is 0 if none of the main threads have been assigned to x. Because |U⁺−L⁺|≤v, for each core, the number of remainder threads assigned to core x can be defined as:

$${R}_{x} = ( {\sum }_{w} {\sum }_{t} {\sum }_{i = 0}^{v - 1} {Y}_{w , t , c = vx + 1} - {L}^{+} ) {M}_{x} ∀ x \qquad Equation 16$$

As Eq. 16 is bounded between 0 and v, the optimization function may sum the remainder threads over all cores x and subtract it from the optimization objective.

$${f}_{core} = {\sum }_{x} {R}_{x} \qquad Equation 17$$

As such, Eq. 17 provides a formalization for one embodiment to distribute the remainder threads across physical cores, optimized in scatter to maximize the distribution across cores, while in compact may be optimized to allow more compact distribution of threads for a given worker. Additional embodiments may provide for core workload distribution in different ways and with different optimizations.

Using the distances as discussed above along with one or more (or all) of the constraints discussed above, the thread mapping module 220 can determine an effective thread mapping for the various multi-threaded workers. This approach allows determining a thread mapping that accounts for different numbers of workers, threads per worker, and differing thread workloads while avoiding thread migration.

### Thread Mapping Process

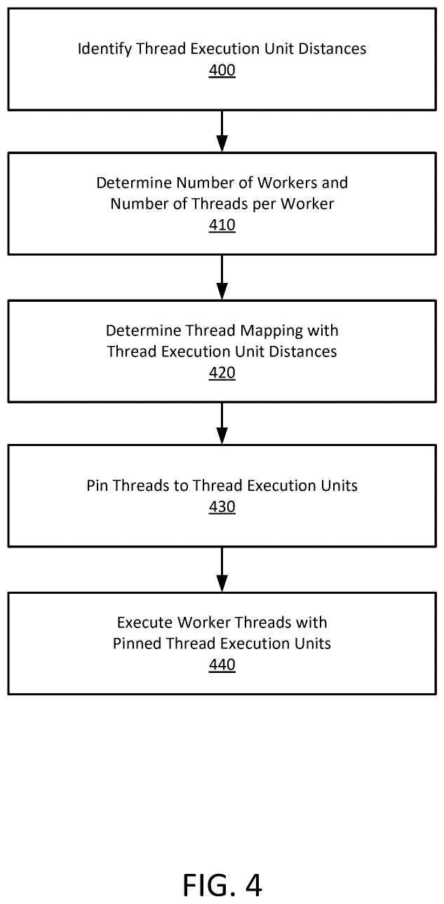

FIG. 4 provides an example process for optimizing thread mapping for a model inference server, according to one or more embodiments. This process may be performed, for example, by a model inference server 110 and particularly by a thread mapping module 220. Initially, the thread mapping process may be performed by determining information about the computing architecture on which the model workers are implemented and the model processes to be optimized. Particularly, the computing architecture may be characterized by identifying 400 thread execution unit distances and other characteristics of the architecture such as the number of computing cores, number of thread execution units, and identifying the distances between the thread execution units. The distance between thread execution units may be evaluated based on the latency between caches of different thread execution units as discussed above. In some circumstances, the distances between thread execution units may be determined experimentally (e.g., with threads on different thread execution units requesting data from one another) as discussed above or may be obtained by other means (e.g., as provided information about the architecture). As discussed above, the distances may be characterized in some embodiments as a matrix of distances. In addition to the processing architecture information, the number of workers and threads per worker are determined 410 for which to optimize thread mapping.

The thread mapping may then be determined 420 based on the threads (e.g., number of workers and threads per worker) and the processing architecture based on the processing thread execution unit distances. As discussed above, the thread mapping may use the distances to evaluate distances across workers (e.g., to maximize distance between main threads of different workers) or within threads of the same worker (e.g., to “spread” threads with increased distance or to “condense” threads with reduced distance). Additional constraints may also be included in the thread mapping process and may include preventing more than one thread for a worker to be assigned to a given thread execution unit, workload considerations across cores and thread execution units, and so forth as discussed above. The thread mapping may be determined by an optimization problem, such as with Integer Linear Programming, or via another suitable means.

After determining the thread mappings, the threads are pinned 430 to the thread execution units 430. The operating system may then execute 440 the threads using the pinned thread execution units 440 and prevent migration of the threads to different thread execution units. In some embodiments, the threads are pinned 430 using configuration instructions for instantiating and executing the threads, for example by a HTTP server process management environment or with environmental configuration parameters.

In some embodiments, mapping of the model inference threads may be “offline” relative to the worker threads. That is, the thread mapping may be performed without requiring the worker threads to be currently executing, and may be determined based on configuration information for the processing architecture and the configuration for the inference model (e.g., the number workers and threads per worker). In addition, in some embodiments, the thread mapping is performed by a system different from the system that implements the thread mapping (i.e., that binds actively executing threads). As such, in some embodiments, information describing the computing architecture and worker configuration (e.g., number of workers and worker threads) is received by one system that generates a thread mapping configuration and a model inference system implements the thread mapping to active workers.

In some embodiments, the output of the mapping designates mapped thread execution units with thread indices that indicate IDs of thread execution units. In some embodiments, the mapping is stored as a set of keys that represent worker indices, and associated values for the keys are a nested mapping that correspond to thread indices within that worker. In instances where the thread mapping is determined “offline,” these indices may be ordinal rather than specifying process or thread identifiers (e.g., PIDs or TIDs). As such, the lowest worker index may map to the lowest PID and the lowest thread index may correspond a main thread (i.e., the thread with the lowest TID under that worker).

When the thread mapping is determined when the worker threads are “offline,” the thread mapping may be applied to bind the worker processes when the model processes are instantiated for the model inference server. As one example using OpenMP, the OpenMP environment variable OMP_PROC_BIND is set to TRUE. This variable is inherited by the OpenMP threads utilized by the XGBoost library and restricts a thread from migrating to another vCPU. The operating system and/or a thread pinning module receives the generated mapping and binds the appropriate threads after the server is started.

### Experimental Data

Thread mappings obtained with the process discussed above was applied in various experiments and compared with alternate thread assignment schemes including the default Linux Completely Fair Scheduler (CFS) and a Round Robin thread assignment. Particularly, the AI inference model used in the experiments is XGBoost, which is an optimized gradient boosting algorithm used for machine learning tasks like regression and classification. In the experiments, XGBoost was implemented with Open Multi-Processing (OpenMP) for parallelization and multi-threading during training and inference.

The experiments investigated deployment of a real-time XGBoost inference service on a Gunicorn server. To leverage multi-threaded model execution within each worker, the OMP NUM THREADS environment variable was set prior to starting the server. This configuration results in a server with a fixed number of workers, each with an independent and equally sized OpenMP thread pool (i.e., the worker process threads 245 shown in FIG. 2) for executing the XGBoost model.

Experiments discussed below were run independently on a node on an Azure Linux Kubernetes cluster (AKS). The node is a Standard_D32ds_v4 compute instance that includes a single socket Intel Xeon Platinum 8272CL @ 2.60 GHz processor with 16 physical cores and 32 logical cores (i.e., thread execution units).

The model inference server 110 of the experiments used a Python application with an XGBoost inference pipeline written in Flask and deployed on a Gunicorn HTTP server. When a request arrives at the server, it first waits in a passive socket queue managed by the operating system before being routed to an available worker. Once routed, a Flask endpoint function is invoked which runs a pipeline of five stages in sequence for the AI process: 1) payload deserialization (single-threaded), 2) data type conversions (single-threaded), 3) DMatrix declaration for XGBoost input (multi-threaded), 4) compute model predictions (multithreaded), 5) compute Shapley feature contribution scores (multi-threaded).

While these five stages may not always be executed together or in this particular sequence, they represent tasks that are commonly encountered in real-time model inference. This pipeline is used in our study to analyze their performance implications.

Initially, computer models (e.g., XGBoost models) were trained for different data sets the and are categorized as small, medium and large. The small model is referred to as the Credit model trained on 29 features of the Credit Card Fraud Detection Kaggle dataset. The medium model is referred to as the Loan model trained on 155 features of the Loan Defaulter Kaggle dataset. The large model is referred to as the MNIST model trained on 784 features of the MNIST in CSV Kaggle dataset.

To evaluate multi-threaded server performance under realistic conditions, this study employs a testing methodology that simulates high concurrency with concurrent batch processing. This approach reflects real-world scenarios where clients submit mini-batches of records to the server to minimize TCP communication overhead, a pattern commonly observed in high-throughput systems. During the experiments, payloads of different sizes were generated from each of the datasets in which a small batch containing 100 records, a medium batch containing 500 records, and a large batch containing 1,000 records.

The thread mapping approach discussed above in which threads are mapped using core-core distances as discussed above is compared in experiments with Round Robin, and the default Linux Completely Fair Scheduler (CFS). Round Robin is implemented by setting OMP_PROC_BIND=TRUE prior to starting the Gunicorn server and sequentially binding each OpenMP thread over all workers in a cyclical pattern (A.2). The CFS does not require any configuration prior to or after starting the Gunicorn server as it is the default scheduling policy on Linux.

While the pipeline remains fixed throughout these experiments, the experiments explored various sources of variation. First, the underlying inference model varies across three sizes: small model with 29 features (Credit), medium model with 155 features (Loan), large model with 784 features (MNIST). Second, experiments varied the number of workers and model thread counts over 36 configurations, {2,4,6,8,12,16} workers×{2,4,6,8,12,16} model threads, resulting in a total of 108 application scenarios. Varying worker and model thread counts helps understand performance variations of the application across different under/oversubscribed environments. An environment is undersubscribed if workers×model threads≤the 32 thread execution units (i.e., logical CPUs) and oversubscribed otherwise, giving a total of 20 (16) over (under) subscribed configurations in the study. Third, application scenarios were load tested under three batch data sizes: 100, 500, 1000 records/request. Varying the model with batch sizes helps understand performance variations across various memory footprints.

Each set of configurations was run independently under the three policies: the thread mapping discussed above, Round Robin, and CFS. A total of 972 application runs (3 policies×3 models×3 batches×36 configurations) were studied.

In aggregating the benefit of the claimed approach across these application runs, the core-core distance-based thread mapping discussed above achieves a runtime speedup of 1.15× and 1.13× over CFS and Round Robin respectively when averaged across the sources of variation.

While the core-core distance-based mapping shows consistent gains over both policies in all groups, gains are smaller in undersubscribed groups, suggesting that CFS is efficient in low contention environments despite its disadvantages. The main strength of the disclosed approach comes from its ability to minimize performance degradation in high contention environments.

As such, the disclosed approach to thread mapping for multithreaded multiple worker AI inference environments provides a meaningful improvement over prior approaches and accounts for the particular characteristics of the workloads of AI inference when implemented in these systems. Particularly, this approach produces thread placement policies to avoid introducing the added complexity and system overhead typically introduced by dynamic mapping policies. It combines the load balancing advantages of the default scheduler through workload-aware constraints and the locality advantages of classic static mapping heuristics, generalized to a multi-process setting. The experiments show consistent outperformance over the Linux default scheduler and Round Robin placement over varying model instances, workload sizes and thread configurations, averaging speedups of 1.13×-1.15×.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for managing execution of model inference workers, comprising:
one or more processing cores comprising a plurality of thread execution units configured for independent thread execution;
a non-transitory computer-readable medium containing instructions executable by one or more processors for:
identifying distances between the plurality of thread execution units;
determining a thread mapping of threads for a plurality of multi-threaded worker processes to the plurality of thread execution units of threads, the thread mapping determined with an Integer Linear Program (ILP) having at least one constraint for the ILP based on the distances between the plurality of thread execution units;
pinning executing threads of the plurality of worker processes to the plurality of thread execution units based on the assigned thread mapping; and
executing the threads of the plurality of multi-threaded worker processes on the pinned thread execution units.

2. The system of claim 1, wherein the mapping includes an objective to maximize distance between main threads of the plurality of multi-threaded worker processes.

3. The system of claim 1, wherein the mapping includes an objective to maximize distance within threads of each of the worker processes in the plurality of multi-threaded worker processes.

4. The system of claim 1, wherein the mapping includes an objective to minimize distance within threads of each of the worker processes in the plurality of multi-threaded worker processes.

5. The system of claim 1, wherein the distance between the plurality of thread execution units is measured by cache access time.

6. The system of claim 5, wherein the cache access time is measured in clock cycles.

7. The system of claim 1, wherein the thread mapping is performed when the multi-threaded worker processes are offline.

8. The system of claim 1, wherein the generated thread mapping is an indexed assignment of threads to the thread execution units.

9. A computer-implemented method for managing execution of model inference workers, comprising:
determining a plurality of thread execution units configured for independent thread execution and distances between the plurality of thread execution units;
determining a number of model inference workers for parallel execution on the plurality of thread execution units;
identifying distances between a plurality of thread execution units configured for independent thread execution;
determining a thread mapping of threads for a plurality of multi-threaded worker processes to the plurality of thread execution units of threads, the thread mapping determined with an Integer Linear Program (ILP) having at least one constraint for the ILP based on the distances between the plurality of thread execution units;
pinning executing threads of the plurality of worker processes to the plurality of thread execution units based on the assigned thread mapping; and
executing the threads of the plurality of multi-threaded worker processes on the pinned thread execution units.

10. The method of claim 9, wherein the mapping includes an objective to maximize distance between main threads of the plurality of multi-threaded worker processes.

11. The method of claim 9, wherein the mapping includes an objective to maximize distance within threads of each of the worker processes in the plurality of multi-threaded worker processes.

12. The method of claim 9, wherein the mapping includes an objective to minimize distance within threads of each of the worker processes in the plurality of multi-threaded worker processes.

13. The method of claim 9, wherein the distance between the plurality of thread execution units is measured by cache access time.

14. The method of claim 13, wherein the cache access time is measured in clock cycles.

15. The method of claim 9, wherein the thread mapping is performed when the multi-threaded worker processes are offline.

16. The method of claim 9, wherein the generated thread mapping is an indexed assignment of threads to the thread execution units.

17. A non-transitory computer-readable medium for managing execution of model inference workers, the non-transitory computer-readable medium comprising instructions executable by a processor for:
determining a plurality of thread execution units configured for independent thread execution and distances between the plurality of thread execution units;
determining a number of model inference workers for parallel execution on the plurality of thread execution units;
identifying distances between a plurality of thread execution units configured for independent thread execution;
determining a thread mapping of threads for a plurality of multi-threaded worker processes to the plurality of thread execution units of threads, the thread mapping determined with an Integer Linear Program (ILP) having at least one constraint for the ILP based on the distances between the plurality of thread execution units;
pinning executing threads of the plurality of worker processes to the plurality of thread execution units based on the assigned thread mapping; and
executing the threads of the plurality of multi-threaded worker processes on the pinned thread execution units.

18. The non-transitory computer-readable medium of claim 17, wherein the mapping includes an objective to maximize distance between main threads of the plurality of multi-threaded worker processes.

19. The non-transitory computer-readable medium of claim 17, wherein the mapping includes an objective to maximize distance within threads of each of the worker processes in the plurality of multi-threaded worker processes.

20. The non-transitory computer-readable medium of claim 17, wherein the mapping includes an objective to minimize distance within threads of each of the worker processes in the plurality of multi-threaded worker processes.
